(19) United States
(12) Patent Application Publication
(10) Pub. No.: US 2015/0064938 A1
(43) Pub. Date: Mar. 5, 2015

(54) PIN MODULE OF RJ CONNECTOR

(71) Applicant: DELTA ELECTRONICS, INC., Kuei San (TW)

(72) Inventor: Chin-Chung TAI, Kuei San (TW)

(73) Assignee: DELTA ELECTRONICS, INC., Kuei San (TW)

(21) Appl. No.: 14/273,868

(22) Filed: May 9, 2014

(30) Foreign Application Priority Data
Aug. 30, 2013 (TW) 102131213

(51) Int. Cl. H01R 13/6469

(52) U.S. Cl. CPC H01R 13/6469
USPC 439/61

(57) ABSTRACT

A pin module of RJ connector includes a circuit board and eight pins, which contain a first pin, a second pin, a third pin, a fourth pin, a fifth pin, a sixth pin, a seventh pin and an eighth pin. Each pin includes a turning part and a stretching part. One end of the turning part is extended to form a first end of the pin. The first ends of the pins are arranged in a series. One end of the stretching part is coupled to the other end of the corresponding turning part. The other end of the stretching part is extended to form a second end of the pin, and the second ends of the pins clips the circuit board.

### CROSS REFERENCE TO RELATED APPLICATIONS

This Non-provisional application claims priority under 35 U.S.C. §119(a) on Patent Application No(s). 102131213 filed in Taiwan, Republic of China on Aug. 30, 2013, the entire contents of which are hereby incorporated by reference.

### BACKGROUND OF THE INVENTION

1. Field of Invention

The present invention relates to an RJ connector and, in particular, to a pin module of the RJ connector.

2. Related Art

With the progress of technologies, the current electronic apparatuses are mostly manufactured with miniaturization and more functions. Besides, for the data transmission between different kinds of electronic apparatuses, several different communication protocols and the connectors thereof are developed for connecting the electronic apparatuses and achieving their data transmission. Recently, the connector mostly used in the network interface is a twisted pair connector, which can be divided into two kinds of a RJ-45 connector and a RJ-11 connector.

Besides, since the electronic apparatus trend to multiple and smart functions, the amount of signal that needs to be transmitted in the whole system is gradually increased. However, at the same time, the electronic components and products trend to the lightness and miniaturization. Accordingly, for the requirements of heavy signal transmission and miniaturization, the RJ connector applied to the high frequency transmission is made with more pins and a smaller size.

However, since the conductive pins of the RJ connector are usually separately installed inside the insulation base in parallel, the adjacent pins may easily generate capacitive coupling when transmitting high-speed or high-frequency signals. This undesired capacitive coupling will cause the crosstalk interference between the pair of adjacent pins, thereby resulting the signal deformation and decay so as to affect the accuracy of the signal transmission and the normal operation of the electronic apparatus. Regarding to the crosstalk interference, a filter device is configured in the connector for minimizing the interference or noise. However, this approach will sufficiently increase the manufacturing cost of the cost and harm the minimization of the connector.

In addition, on the signal transmission route of the transmission system, the conductive pins can easily generate impedance mismatch, which further causes the insertion loss of the signal transmission so as to decrease the signal transmission quality.

Therefore, it is an important subject to provide a pin module of an RJ connector that has a simple design and configuration for preventing the crosstalk interference and insertion loss of the high-frequency signal transmission, thereby effectively improving the signal transmission quality and increasing the signal transmission efficiency.

### SUMMARY OF THE INVENTION

In view of the foregoing subject, an objective of the present invention is to provide a pin module of an RJ connector that has a simple design and configuration for preventing the crosstalk interference and insertion loss of the high-frequency signal transmission, thereby effectively improving the signal transmission quality and increasing the signal transmission efficiency.

To achieve the above objective, the present invention discloses a pin module of an RJ connector. The pin module includes a circuit board and eight pins, which contain a first pin, a second pin, a third pin, a fourth pin, a fifth pin, a sixth pin, a seventh pin and an eighth pin. Each pin includes a turning part and a stretching part, and one end of the turning part is extended to form a first end of the corresponding pin. The first ends of the eight pins are arranged in a series. One end of the stretching part is coupled to the other end of the corresponding turning part, and the other end of the stretching part is extended to form a second end of the corresponding pin. The second ends of the eight pins clip the circuit board.

In one embodiment, the second ends of the first pin, the second pin, the third pin and the fourth pin are disposed on a first surface of the circuit board, and the second ends of the fifth pin, the sixth pin, the seventh pin and the eighth pin are disposed on a second surface of the circuit board.

In one embodiment, the projection of the second end of the third pin on the circuit board is not overlapped with the projection of the second end of the sixth pin on the circuit board.

In one embodiment, the projection of the second end of the fourth pin on the circuit board is not overlapped with the projection of the second end of the fifth pin on the circuit board.

In one embodiment, each of the stretching parts of the third pin and the sixth pin further includes a first section, a second section and a bending section coupled to the first section and the second section.

In one embodiment, the length of the first section is smaller that that of the second section.

To achieve the above objective, the present invention also discloses a pin module of an RJ connector, which includes a circuit board and eight pins. The eight pins contain a first pin, a second pin, a third pin, a fourth pin, a fifth pin, a sixth pin, a seventh pin and an eighth pin. Each pin includes a turning part, a stretching part and a bending part. One end of the turning part is extended to form a first end of the corresponding pin, and the first ends of the eight pins are arranged in a series. One end of the stretching part is coupled to the other end of the corresponding turning part. One end of the bending part is coupled to the other end of the corresponding stretching part, and the other end of the bending part is extended to form a second end of the corresponding pin. Each bending part has at least one bending. The second ends of the pins clip the circuit board.

In one embodiment, the second ends of the first pin, the second pin, the third pin and the fourth pin are disposed on a first surface of the circuit board, and the second ends of the fifth pin, the sixth pin, the seventh pin and the eighth pin are disposed on a second surface of the circuit board.

In one embodiment, the second ends of the first pin and the second pin are misaligned with the second ends of the eighth pin and the seventh pin.

In one embodiment, the projection of the second end of the third pin on the circuit board is not overlapped with the projection of the second end of the sixth pin on the circuit board.

In one embodiment, the projection of the second end of the fourth pin on the circuit board is not overlapped with the projection of the second end of the fifth pin on the circuit board.

To achieve the above objective, the present invention further discloses a pin module of an RJ connector, which includes a circuit board and eight pins. The eight pins contain a first pin, a second pin, a third pin, a fourth pin, a fifth pin, a sixth pin, a seventh pin and an eighth pin. Each pin includes a turning part and a stretching part. One end of the turning part is extended to form a first end of the corresponding pin, and the first ends of the eight pins are arranged in a series. One end of the stretching part is coupled to the other end of the corresponding turning part. Each of the other ends of the stretching parts of the first, second, seventh and eighth pins is coupled to one end of a bending part, which has at least one bending. The other ends of the bending parts are extended to form second ends of the first, second, seventh and eighth pins, respectively. The other ends of the stretching parts of the third, fourth, fifth and sixth pins are extended to form second ends of the third, fourth, fifth and sixth pins, respectively. The second ends of the pins clip the circuit board.

In one embodiment, the second ends of the first pin, the second pin, the third pin and the fourth pin are disposed on a first surface of the circuit board, and the second ends of the fifth pin, the sixth pin, the seventh pin and the eighth pin are disposed on a second surface of the circuit board.

In one embodiment, each of the stretching parts of the third pin and the sixth pin further comprises a first section, a second section and a bending section coupled to the first section and the second section. In one embodiment, the length of the first section is smaller that that of the second section.

In one embodiment, the projection of the second end of the third pin on the circuit board is not overlapped with the projection of the second end of the sixth pin on the circuit board.

In one embodiment, the projection of the second end of the fourth pin on the circuit board is not overlapped with the projection of the second end of the fifth pin on the circuit board.

In one embodiment, the second ends of the first pin and the second pin are misaligned with the second ends of the eighth pin and the seventh pin.

As mentioned above, the pin module of the RJ connector of the invention has novel pin shape and pin configuration for effectively improving the signal transmission efficiency and effect of the RJ connector. In addition, the novel pin design can further decrease the capacitive coupling of high-frequency signal transmission, so that the crosstalk interference can be reduced. Compared with the conventional art, the present invention uses simple design and process to achieve the goal of improving signal resolution and accuracy rather than configuring the additional filter.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1A is a schematic diagram showing a pin module of an RJ connector according to a preferred embodiment of the invention;

FIG. 1B and FIG. 1C are schematic diagrams showing eight pins of the pin module of the RJ connector according to the embodiment of the invention;

FIG. 2A is a schematic diagram showing a pin module of an RJ connector according to another embodiment of the invention;

FIG. 2B and FIG. 2C are schematic diagrams showing eight pins of the pin module of the RJ connector of FIG. 2A;

FIG. 3A is a schematic diagram showing a pin module of an RJ connector according to another embodiment of the invention;

FIG. 3B is a schematic diagram showing eight pins of the pin module of the RJ connector of FIG. 3A; and

FIG. 3C is a schematic diagram showing four pins of the pin module of the RJ connector of FIG. 3A.

### DETAILED DESCRIPTION OF THE INVENTION

The present invention will be apparent from the following detailed description, which proceeds with reference to the accompanying drawings, wherein the same references relate to the same elements.

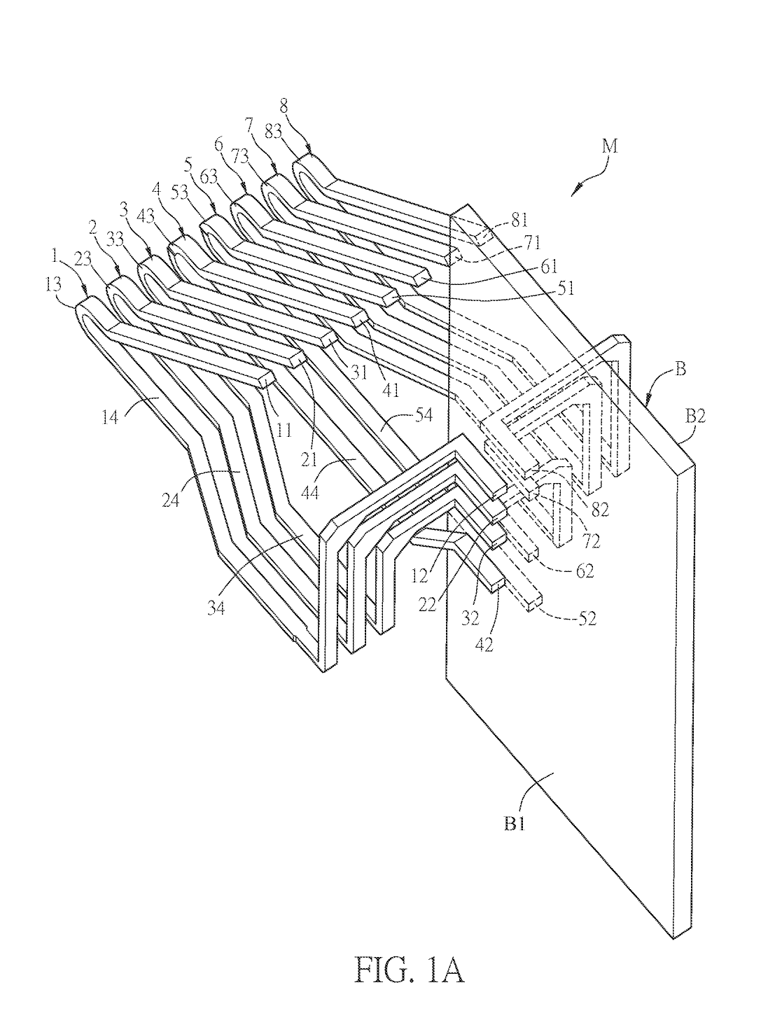

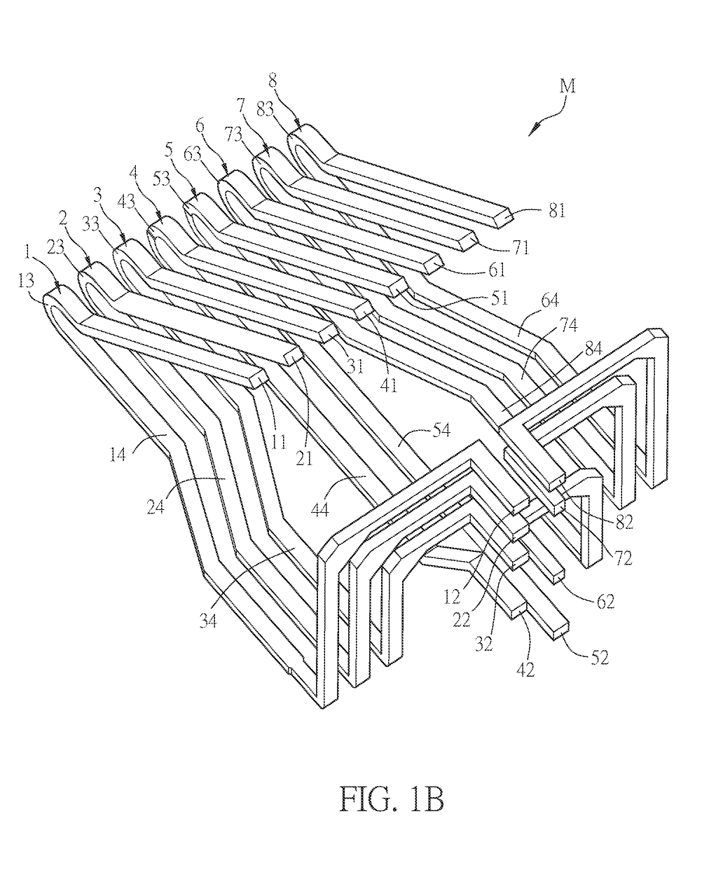

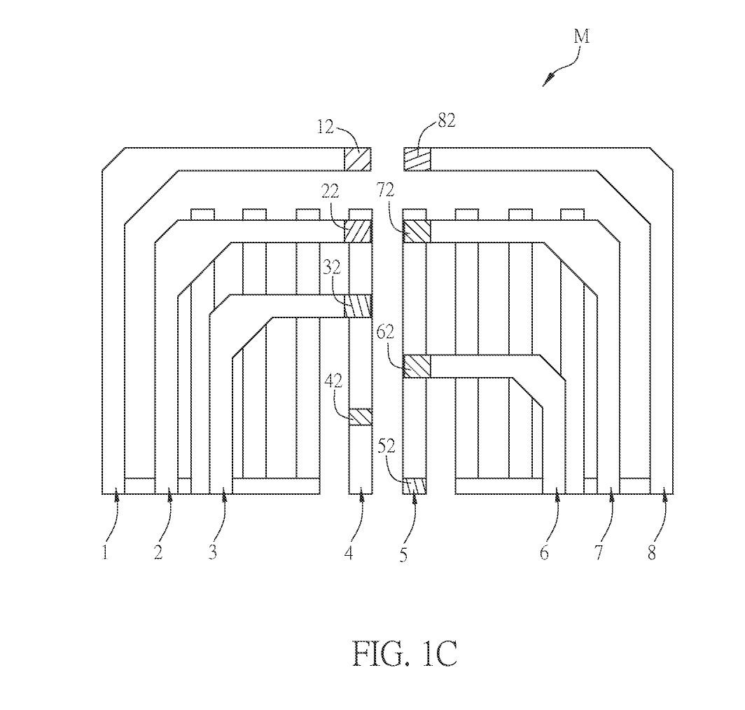

FIG. 1A is a schematic diagram showing a pin module of an RJ connector according to a preferred embodiment of the invention, and FIGS. 1B and 1C are schematic diagrams showing eight pins of the pin module of the RJ connector according to the embodiment of the invention. Referring to FIGS. 1A, 1B and 1C, the pin module M includes a circuit board B and eight pins, which contain a first pin 1, a second pin 2, a third pin 3, a fourth pin 4, a fifth pin 5, a sixth pin 6, a seventh pin 7, and an eighth pin 8. In this embodiment, the pin module M of the RJ connector is applied to the Netcom connectors. In practice, the pin module M is applied cooperating with, for example but not limited to, a modular jack. Of course, the pin module M can be applied to any electric connector with the structure of the RJ connector, and this invention is not limited thereto. The circuit board B is, for example but not limited to, a printed circuit board (PCB), which has a plurality conductive pads for electrically connecting with the pins.

As shown in FIGS. 1A, 1B and 1C, the first pin 1 includes a turning part 13 and a stretching part 14, the second pin 2 includes a turning part 23 and a stretching part 24, the third pin 3 includes a turning part 33 and a stretching part 34, the fourth pin 4 includes a turning part 43 and a stretching part 44, the fifth pin 5 includes a turning part 53 and a stretching part 54, the sixth pin 6 includes a turning part 63 and a stretching part 64, the seventh pin 7 includes a turning part 73 and a stretching part 74, and the eighth pin 8 includes a turning part 83 and a stretching part 84.

One ends of the turning parts 13, 23, 33, 43, 53, 63, 73 and 83 are extended to form the first ends 11, 21, 31, 41, 51, 61, 71 and 81 of the first pin 1, the second pin 2, the third pin 3, the fourth pin 4, the fifth pin 5, the sixth pin 6, the seventh pin 7 and the eighth pin 8, respectively. The first ends 11, 21, 31, 41, 51, 61, 71 and 81 are arranged in a series.

One ends of the stretching parts 14, 24, 34, 44, 54, 64, 74 and 84 are coupled to the other ends of the corresponding turning parts 13, 23, 33, 43, 53, 63, 73 and 83, respectively. The other ends of the stretching parts 14, 24, 34, 44, 54, 64, 74 and 84 are extended to form second ends 12, 22, 32, 42, 52, 62, 72 and 82 of the first pin 1, the second pin 2, the third pin 3, the fourth pin 4, the fifth pin 5, the sixth pin 6, the seventh pin 7 and the eighth pin 8, respectively.

To be noted, the eight pins are grouped into four signal pairs, and every signal pair includes two pins. In this case, the first and second pins 1 and 2 are a signal pair, the fourth and fifth pins 4 and 5 are a signal pair, the seventh and eighth pins 7 and 8 are a signal pair, and the third and sixth pins 3 and 6 are a signal pair.

The second end 12 of the first pin 1, the second end 22 of the second pin 2, the second end 32 of the third pin 3 and the second end 42 of the fourth pin 4 are disposed on a first surface B1 of the circuit board B. The second end 52 of the fifth pin 5, the second end 62 of the sixth pin 6, the second end 72 of the seventh pin 7 and the second end 82 of the eighth pin 8 are disposed on a second surface B2 of the circuit board B. The second ends 12, 22, 32, 42, 52, 62, 72 and 82 of the pins clip the circuit board B.

In this embodiment, the stretching parts 14, 24 and 34 of the first, second and third pins 1, 2 and 3 are configured corresponding to the stretching parts 84, 74 and 64 of the eighth, seventh and sixth pins 8, 7 and 6. In addition, the stretching parts are extended oppositely and then bent perpendicularly, thereby stretching to form the second ends 12, 22, 32, 62, 72 and 82. This configuration and structure can decrease the transmission interference and insertion loss of the signal transmission.

Besides, in this embodiment, the projection of the second end 32 of the third pin 3 on the circuit board B is not overlapped with the projection of the second end 62 of the sixth pin 6 on the circuit board B. In other words, the second end 32 of the third pin 3 and the second end 62 of the sixth pin 6 are misaligned on the direction of the circuit board B. This configuration and design can reduce the signal delay of the signal pair transmitting through the third pin 3 and the sixth pin 6.

Similarly, in this embodiment, the projection of the second end 42 of the fourth pin 4 on the circuit board B is not overlapped with the projection of the second end 52 of the fifth pin 5 on the circuit board B. This configuration can reduce the signal delay of the signal pair transmitting through the fourth pin 4 and the fifth pin 5.

To be noted, in this embodiment, the second end 32 of the third pin 3 and the second end 62 of the sixth pin 6 are misaligned, and the second end 42 of the fourth pin 4 and the second end 52 of the fifth pin 5 are misaligned. However, in other embodiments, the arrangement of the second ends can be various depending on the actual requirement. For example, only the second end 32 of the third pin 3 and the second end 62 of the sixth pin 6 are misaligned, or only the second end 42 of the fourth pin 4 and the second end 52 of the fifth pin 5 are misaligned. Of course, the second ends 12, 22, 32 and 42 disposed on the first surface B1 of the circuit board B are all misaligned with the second ends 82, 72, 62 and 52 disposed on the second surface B2 of the circuit board B.

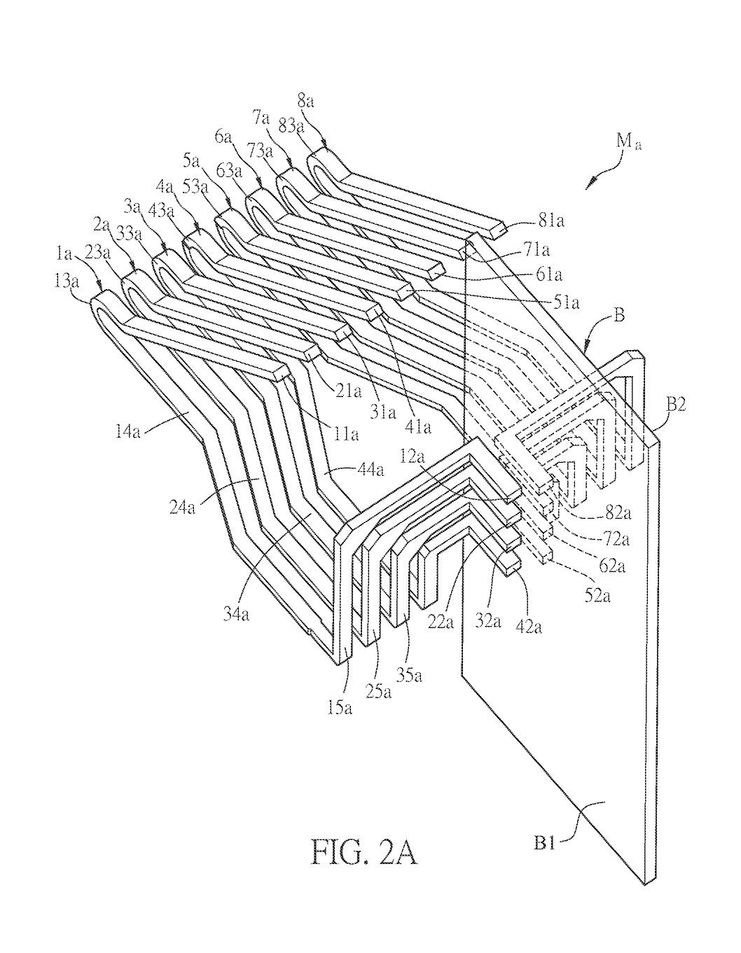

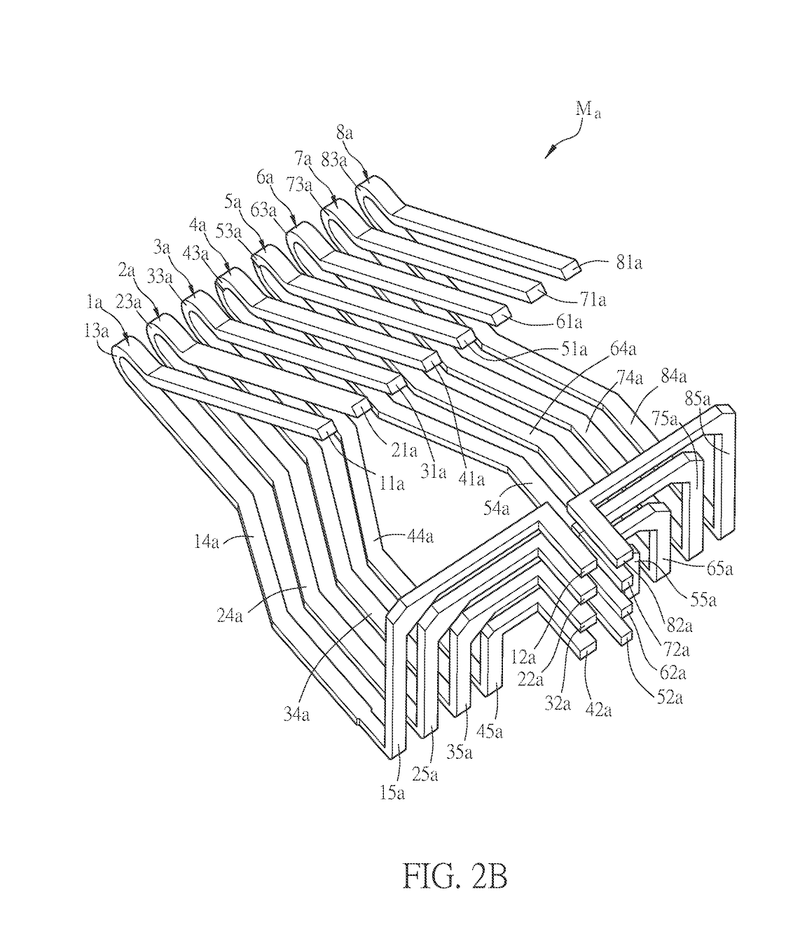

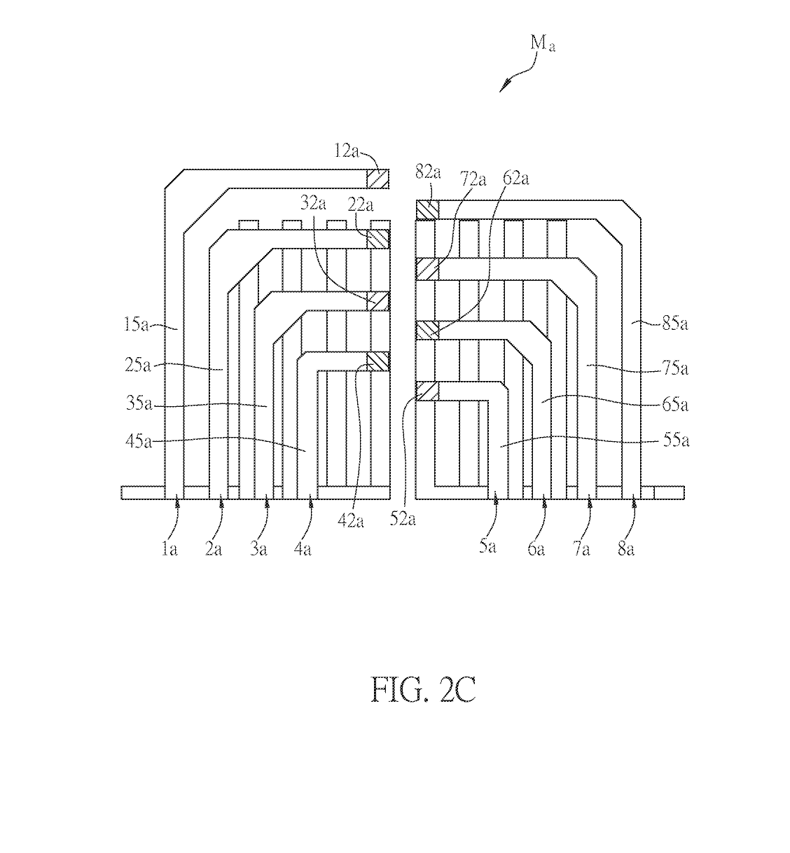

FIG. 2A is a schematic diagram showing another pin module of an RJ connector according to the embodiment of the invention, and FIGS. 2B and 2C are schematic diagrams showing eight pins of the pin module of the RJ connector of FIG. 2A. Referring to FIGS. 2A, 2B and 2C, the pin module Ma includes a circuit board B and eight pins, which contain a first pin 1a, a second pin 2a, a third pin 3a, a fourth pin 4a, a fifth pin 5a, a sixth pin 6a, a seventh pin 7a, and an eighth pin 8a. The hardware aspects of the RJ connector and the circuit board B can be referred to the previous embodiment, so the detailed description thereof will be omitted.

The first pin 1a includes a turning part 13a, a stretching part 14a and a bending part 15a, the second pin 2a includes a turning part 23a, a stretching part 24a and a bending part 25a, the third pin 3a includes a turning part 33a, a stretching part 34a and a bending part 35a, the fourth pin 4a includes a turning part 43a, a stretching part 44a and a bending part 45a, the fifth pin 5a includes a turning part 53a, a stretching part 54a and a bending part 55a, the sixth pin 6a includes a turning part 63a, a stretching part 64a and a bending part 65a, the seventh pin 7a includes a turning part 73a, a stretching part 74a and a bending part 75a, and the eighth pin 8a includes a turning part 83a, a stretching part 84a and a bending part 85a.

One ends of the turning parts 13a, 23a, 33a, 43a, 53a, 63a, 73a and 83a are extended to form the first ends 11a, 21a, 31a, 41a, 51a, 61a, 71a and 81a of the first pin 1a, the second pin 2a, the third pin 3a, the fourth pin 4a, the fifth pin 5a, the sixth pin 6a, the seventh pin 7a and the eighth pin 8a, respectively. The first ends 11a, 21a, 31a, 41a, 51a, 61a, 71a and 81a are arranged in a series.

One ends of the stretching parts 14a, 24a, 34a, 44a, 54a, 64a, 74a and 84a are coupled to the other ends of the turning parts 13a, 23a, 33a, 43a, 53a, 63a, 73a and 83a, respectively. The stretching parts 14a, 24a, 34a and 44a are disposed corresponding to the other stretching parts 84a, 74a, 64a and 54a, and the stretching parts are away from each other on the disposing plane.

One ends of the bending parts 15a, 25a, 35a, 45a, 55a, 65a, 75a and 85a are coupled to the other ends of the stretching parts 14a, 24a, 34a, 44a, 54a, 64a, 74a and 84a, respectively. Each of the bending parts 15a, 25a, 35a, 45a, 55a, 65a, 75a and 85a has at least one bending. Besides, the other ends of the bending parts 15a, 25a, 35a, 45a, 55a, 65a, 75a and 85a are extended to from second ends 12a, 22a, 32a, 42a, 52a, 62a, 72a and 82a of the corresponding pins 1-8. In more specific, the plane of the bending parts 15a, 25a, 35a, 45a, 55a, 65a, 75a and 85a is perpendicular to the plane of the stretching parts 14a, 24a, 34a, 44a, 54a, 64a, 74a and 84a. Moreover, the bending parts 15a, 25a, 35a, 45a, 55a, 65a, 75a and 85a are bent and extended toward a central line so as to form the second ends 12a, 22a, 32a, 42a, 52a, 62a, 72a and 82a. The pins 1-8 clip the circuit board B through the second ends 12a, 22a, 32a, 42a, 52a, 62a, 72a and 82a.

In this embodiment, the second end 12a of the first pin 1a, the second end 22a of the second pin 2a, the second end 32a of the third pin 3a and the second end 42a of the fourth pin 4a are disposed on a first surface B1 of the circuit board B. The second end 52a of the fifth pin 5a, the second end 62a of the sixth pin 6a, the second end 72a of the seventh pin 7a and the second end 82a of the eighth pin 8a are disposed on a second surface B2 of the circuit board B. The second end 12a of the third pin 1a and the second end 22a of the second pin 2a are misaligned with the second end 82a of the eighth pin 8a and the second end 72a of the seventh pin 7a. In other words, the projection of the second end 82a of the eighth pin 8a on the circuit board B is located between the projections of the second ends 12a and 22a of the first pin 1a and the second pin 2a on the circuit board B. Besides, the projection of the second end 22a of the second pin 2a on the circuit board B is located between the projections of the second ends 82a and 72a of the eighth pin 8a and the seventh pin 7a on the circuit board B.

Besides, in this embodiment, the projection of the second end 32a of the third pin 3a on the circuit board B is not overlapped with the projection of the second end 62a of the sixth pin 6a on the circuit board B. In other words, the second end 32a of the third pin 3a and the second end 62a of the sixth pin 6a are misaligned on the direction of the circuit board B. This configuration and design can reduce the signal delay of the signal pair transmitting through the third pin 3a and the sixth pin 6a.

Similarly, in this embodiment, the projection of the second end 42a of the fourth pin 4a on the circuit board B is not overlapped with the projection of the second end 52a of the fifth pin 5a on the circuit board B. This configuration can reduce the signal delay of the signal pair transmitting through the fourth pin 4a and the fifth pin 5a.

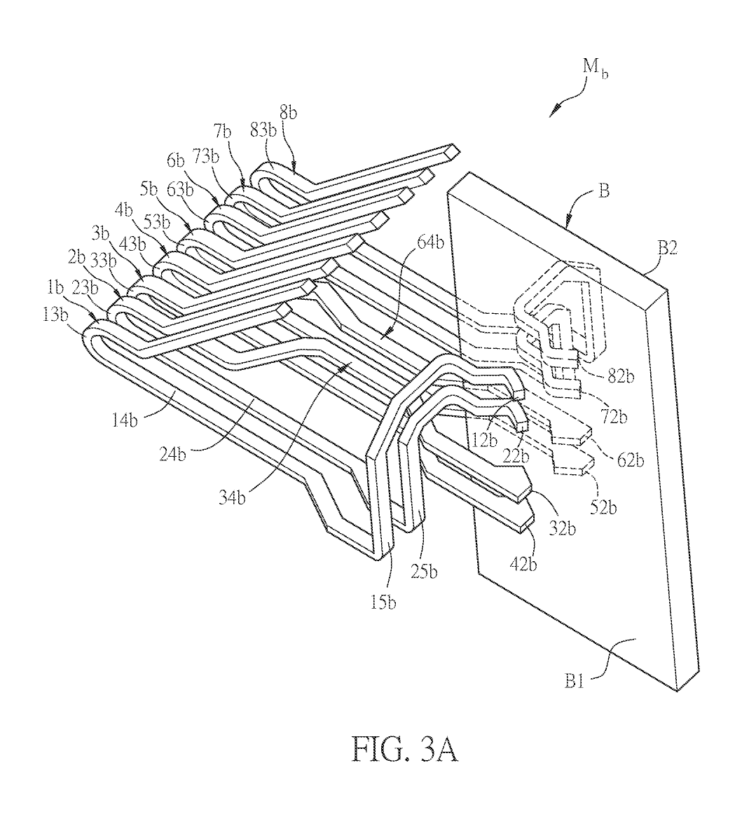

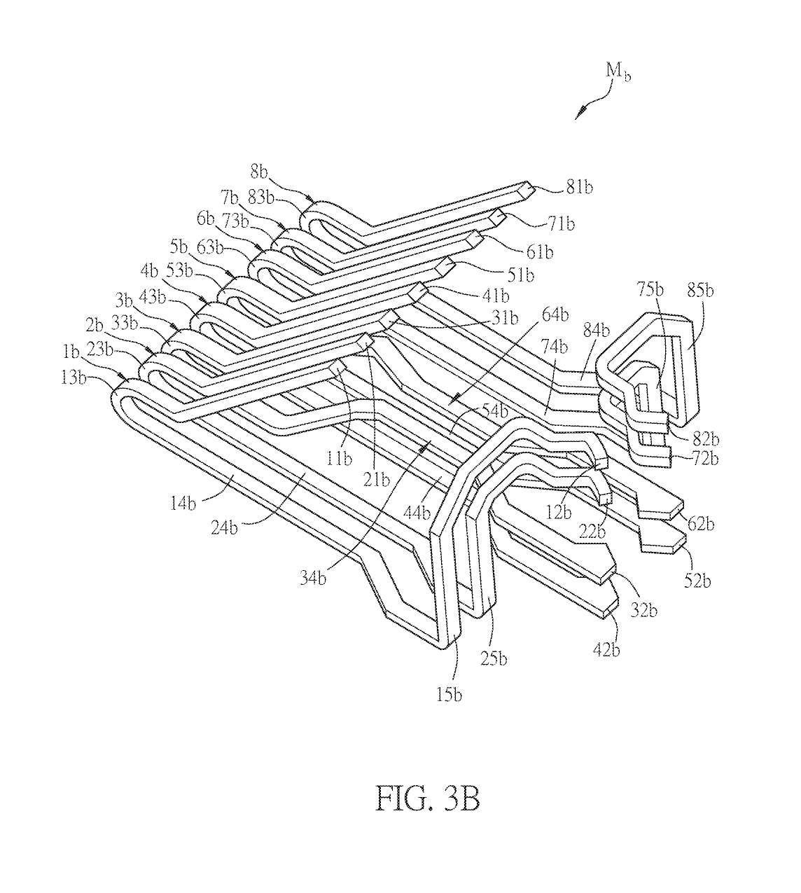

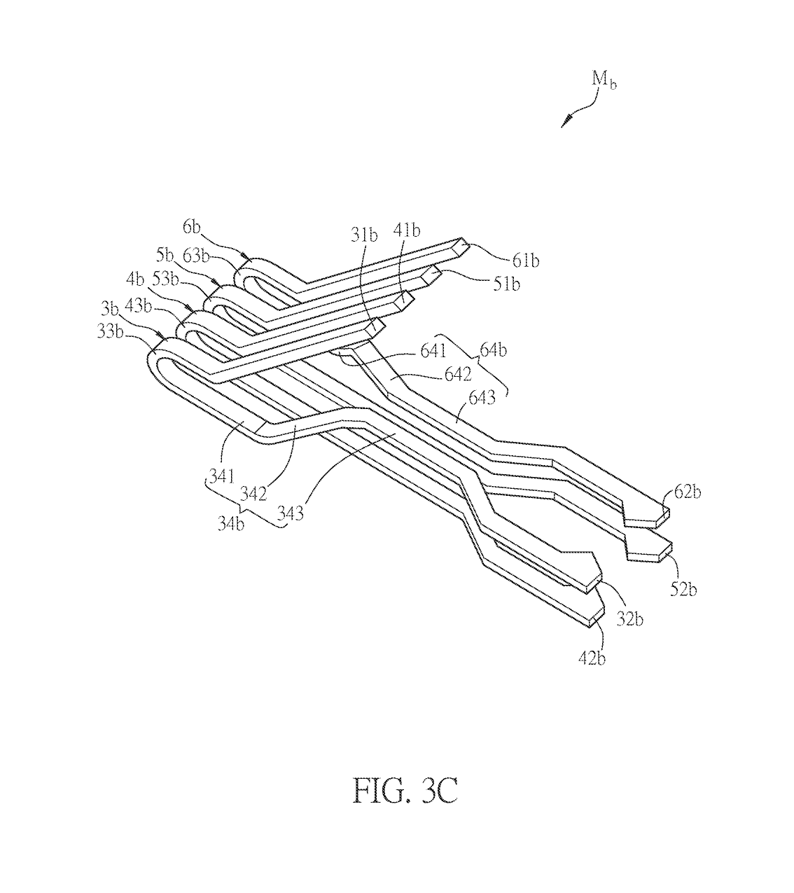

FIG. 3A is a schematic diagram showing another pin module of an RJ connector according to the embodiment of the invention, FIG. 3B is a schematic diagram showing eight pins of the pin module of the RJ connector of FIG. 3A, and FIG. 3C is a schematic diagram showing four pins of the pin module of the RJ connector of FIG. 3A. Referring to FIGS. 3A, 3B and 3C, the pin module Mb includes a circuit board B and eight pins, which contain a first pin 1b, a second pin 2b, a third pin 3b, a fourth pin 4b, a fifth pin 5b, a sixth pin 6b, a seventh pin 7b, and an eighth pin 8b. The hardware aspects of the RJ connector and the circuit board B can be referred to the previous embodiment, so the detailed description thereof will be omitted.

The first pin 1b includes a turning part 13b and a stretching part 14b, the second pin 2b includes a turning part 23b and a stretching part 24b, the third pin 3b includes a turning part 33b and a stretching part 34b, the fourth pin 4b includes a turning part 43b and a stretching part 44b, the fifth pin 5b includes a turning part 53b and a stretching part 54b, the sixth pin 6b includes a turning part 63b and a stretching part 64b, the seventh pin 7b includes a turning part 73b and a stretching part 74b, and the eighth pin 8b includes a turning part 83b and a stretching part 84b.

One ends of the turning parts 13b, 23b, 33b, 43b, 53b, 63b, 73b and 83b are extended to form the first ends 11b, 21b, 31b, 41b, 51b, 61b, 71b and 81b of the first pin 1b, the second pin 2b, the third pin 3b, the fourth pin 4b, the fifth pin 5b, the sixth pin 6b, the seventh pin 7b and the eighth pin 8b, respectively. The first ends 11b, 21b, 31b, 41b, 51b, 61b, 71b and 81b are arranged in a series.

In this embodiment, the other ends of the stretching parts 13b, 23b, 73b and 83b of the first pin 1b, the second pin 2b, the seventh pin 7b and the eighth pin 8b are coupled to one ends of the bending parts 15b, 25b, 75b and 85b, respectively. Each of the bending parts 15b, 25b, 75b and 85b includes at least one bending. The other ends of the bending parts 15b, 25b, 75b and 85b are extended to form the second ends 12b, 22b, 72b and 82b of the first pin 1b, the second pin 2b, the seventh pin 7b and the eighth pin 8b.

The other ends of the stretching parts 33b, 43b, 53b and 63b of the third pin 3b, the fourth pin 4b, the fifth pin 5b and the sixth pin 6b are extended to form the second ends 32b, 42b, 52b and 62b of the third pin 3b, the fourth pin 4b, the fifth pin 5b and the sixth pin 6b.

The second end 12b of the first pin 1b, the second end 22b of the second pin 2b, the second end 32b of the third pin 3b and the second end 42b of the fourth pin 4b are disposed on a first surface B1 of the circuit board B. The second end 52b of the fifth pin 5b, the second end 62b of the sixth pin 6b, the second end 72b of the seventh pin 7b and the second end 82b of the eighth pin 8b are disposed on a second surface B2 of the circuit board B. The second ends 12b, 22b, 32b, 42b, 52b, 62b, 72b and 82b of the pins clip the circuit board B.

In this embodiment, the stretching parts 14b and 24b of the first and second pins 1b and 2b are configured corresponding to the stretching parts 84b and 74b of the eighth and seventh pins 8b and 7b. The stretching parts are disposed away from each other on their plane. The stretching part 34b of the third pin 3b includes a first section 341, a second section 342 and a bending section 343, and the sixth stretching part 64b of the sixth pin 6b includes a first section 641, a second section 642 and a bending section 643. The bending section 343 is coupled to the first section 341 and the second section 342, and the bending section 643 is coupled to the first section 641 and the second section 642. In addition, the length of the first section 341 is smaller than that of the second section 342, and the length of the first section 641 is smaller than that of the second section 642.

Accordingly, the four signal pairs can be kept with a larger interval, while the two pins of each signal pair can have smaller distance. In other words, the design of the invention can effectively minimize the crosstalk interference between the signal pairs, and decrease the transmission loss as the signals transmit through the two pins of each signal pair.

In other embodiments, the arrangement of the second ends can be various depending on the actual requirement. For example, the second end 32b of the third pin 3b and the second end 62b of the sixth pin 6b are misaligned, or the second end 42b of the fourth pin 4b and the second end 52b of the fifth pin 5b are misaligned. Of course, the second ends 12b, 22b, 32b and 42b disposed on the first surface B1 of the circuit board B are all misaligned with the second ends 82b, 72b, 62b and 52b disposed on the second surface B2 of the circuit board B.

To be noted, the above embodiments teach that the circuit board is clipped by the second ends of the pins. In practice, the circuit board can be chipped by the pins in advance and then fixed by welding. This invention is not limited.

In summary, the pin module of the RJ connector of the invention has novel pin shape and pin configuration for effectively improving the signal transmission efficiency and effect of the RJ connector. In addition, the novel pin design can further decrease the capacitive coupling of high-frequency signal transmission, so that the crosstalk interference can be reduced. Compared with the conventional art, the present invention uses simple design and process to achieve the goal of improving signal resolution and accuracy rather than configuring the additional filter.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A pin module of an RJ connector, comprising:
a circuit board; and
eight pins, which contain a first pin, a second pin, a third pin, a fourth pin, a fifth pin, a sixth pin, a seventh pin and an eighth pin, wherein each of the pins comprises a turning part and a stretching part, one end of the turning part is extended to form a first end of the corresponding pin, the first ends of the eight pins are arranged in a series, one end of the stretching part is coupled to the other end of the corresponding turning part, the other end of the stretching part is extended to form a second end of the corresponding pin, and the second ends of the pins clip the circuit board.

2. The pin module of claim 1, wherein the second ends of the first pin, the second pin, the third pin and the fourth pin are disposed on a first surface of the circuit board, and the second ends of the fifth pin, the sixth pin, the seventh pin and the eighth pin are disposed on a second surface of the circuit board.

3. The pin module of claim 2, wherein the projection of the second end of the third pin on the circuit board is not overlapped with the projection of the second end of the sixth pin on the circuit board.

4. The pin module of claim 2, wherein the projection of the second end of the fourth pin on the circuit board is not overlapped with the projection of the second end of the fifth pin on the circuit board.

5. The pin module of claim 2, wherein each of the stretching parts of the third pin and the sixth pin further comprises a first section, a second section and a bending section coupled to the first section and the second section.

6. The pin module of claim 5, wherein the length of the first section is smaller that that of the second section.

7. A pin module of an RJ connector, comprising:
a circuit board; and
eight pins, which contain a first pin, a second pin, a third pin, a fourth pin, a fifth pin, a sixth pin, a seventh pin and an eighth pin, wherein each of the pins comprises a turning part, a stretching part and a bending part, one end of the turning part is extended to form a first end of the corresponding pin, the first ends of the eight pins are arranged in a series, one end of the stretching part is coupled to the other end of the corresponding turning part, one end of the bending part is coupled to the other end of the corresponding stretching part, each of the bending parts has at least one bending, the other end of the bending part is extended to form a second end of the corresponding pin, and the second ends of the pins clip the circuit board.

8. The pin module of claim 7, wherein the second ends of the first pin, the second pin, the third pin and the fourth pin are disposed on a first surface of the circuit board, and the second ends of the fifth pin, the sixth pin, the seventh pin and the eighth pin are disposed on a second surface of the circuit board.

9. The pin module of claim 8, wherein the second ends of the first pin and the second pin are misaligned with the second ends of the eighth pin and the seventh pin.

10. The pin module of claim 9, wherein the projection of the second end of the third pin on the circuit board is not overlapped with the projection of the second end of the sixth pin on the circuit board.

11. The pin module of claim 9, wherein the projection of the second end of the fourth pin on the circuit board is not overlapped with the projection of the second end of the fifth pin on the circuit board.

12. A pin module of an RJ connector, comprising:
a circuit board; and
eight pins, which contain a first pin, a second pin, a third pin, a fourth pin, a fifth pin, a sixth pin, a seventh pin and an eighth pin, wherein each of the pins comprises a turning part and a stretching part, one end of the turning part is extended to form a first end of the corresponding pin, the first ends of the eight pins are arranged in a series, one end of the stretching part is coupled to the other end of the corresponding turning part,
wherein, each of the other ends of the stretching parts of the first pin, the second pin, the seventh pin and the eighth pin is coupled to one end of a bending part, each of the bending parts has at least one bending, the other ends of the bending parts are extended to form second ends of the first pin, the second pin, the seventh pin and the eighth pin, respectively, the other ends of the stretching parts of the third pin, the fourth pin, the fifth pin and the sixth pin are extended to form second ends of the third pin, the fourth pin, the fifth pin and the sixth pin, respectively, and the second ends of the pins clip the circuit board.

13. The pin module of claim 12, wherein the second ends of the first pin, the second pin, the third pin and the fourth pin are disposed on a first surface of the circuit board, and the second ends of the fifth pin, the sixth pin, the seventh pin and the eighth pin are disposed on a second surface of the circuit board.

14. The pin module of claim 13, wherein each of the stretching parts of the third pin and the sixth pin further comprises a first section, a second section and a bending section coupled to the first section and the second section.

15. The pin module of claim 14, wherein the length of the first section is smaller that that of the second section.

16. The pin module of claim 15, wherein the projection of the second end of the third pin on the circuit board is not overlapped with the projection of the second end of the sixth pin on the circuit board.

17. The pin module of claim 15, wherein the projection of the second end of the fourth pin on the circuit board is not overlapped with the projection of the second end of the fifth pin on the circuit board.

18. The pin module of claim 15, wherein the second ends of the first pin and the second pin are misaligned with the second ends of the eighth pin and the seventh pin.
